(19) United States
(12) Patent Application Publication
(10) Pub. No.: US 2012/0198628 A1
(43) Pub. Date: Aug. 9, 2012

(54) MANUALLY REMOVABLE FOOT SECTION

(76) Inventor: Sandy M. RICHARDS, Pershing, IN (US)

(21) Appl. No.: 13/020,190

(22) Filed: Feb. 3, 2011

(51) Int. Cl. A61G 7/053; A61G 7/16; A61G 7/015

(52) U.S. Cl. 5/618

(57) ABSTRACT

A patient support apparatus includes a removable deck section supported on a support structure that acts as a step for a patient as they egress from the patient support apparatus when the removable deck section is removed. The support structure is pivotable relative to a section of the patient support apparatus between a raised position supporting the removable deck section and a lowered position where the step is positioned for use during egress from the bed.

### BACKGROUND

The present invention relates generally to a patient support apparatus movable between a bed position and a chair egress position. More specifically, the present invention relates to a patient support apparatus with a removable deck section supported on a support structure that acts as a step for a patient as they egress from the patient support apparatus when the removable deck section is removed.

Patient support apparatuses, such as hospital beds, for example, may includes a deck having a foot deck section to support the lower legs with the foot deck section being extendable or retractable. In patient support apparatuses that move to a chair egress position, such as the Hill-Rom® TotalCare® bed, the foot deck section may retract to prevent interference with the floor when the foot deck section is lowered to a generally vertical position. Retraction of the foot deck section may be accomplished through a powered drive and components telescope or nest within each other when the foot deck section is retracted. An additional powered drive may be used to lower the foot deck section to the generally vertical position. The height of the bed during the chair egress process is chosen based on the height of the patient so that an appropriate height can be chosen to allow the user to have solid footing on the floor below the bed. The achievable minimum height may be limited by the retracted length of the foot deck section.

In some beds, such as bed used during the birthing process, a portion of the bed deck is removable to permit a caregiver improved access during the birthing process. In still other beds, a portion of the foot section pivots downwardly relative to the remainder of the foot section to create a space where a patient may stand during the chair egress process. Limitations on the minimum height achievable by the bed may cause shorter patients to be unable to reach the floor with their feet while sitting on a support surface of the bed during the egress process.

### SUMMARY

The present application discloses one or more of the features recited in the appended claims and/or the following features which alone or in any combination, may comprise patentable subject matter.

According to a first aspect of the present disclosure, a patient support apparatus may include a lower frame and an upper frame supported on the lower frame and vertically movable relative to the lower frame. The patient support apparatus may also include a first deck section pivotably coupled to the upper frame and a second deck section pivotably coupled to the first deck section. The second deck section may include a pair of support arms spaced apart to define a space therebetween. Each support arm may have an upper surface. The second deck section may also include a support structure pivotable relative to the pair of support arms between a first position and a second position. The patient support apparatus may also include a removable deck section supported on the support structure. An upper surface of the removable deck section may cooperate with the upper surfaces of the pair of support arms to form a generally continuous planar support surface when the support structure is in the first position.

The support structure may include a step and when the support structure is in the second position, the step may be positioned such that the patient support apparatus forms a chair from which a patient may egress.

The support structure may be coupled to an actuator. The actuator may be movable to cause the support structure to move between the first and second positions. The actuator may be supported on the second deck section. The actuator may be an electrically powered linear actuator that may be adjusted to a plurality of lengths. Each length of the linear actuator may correspond to a different position of the support structure relative to the support arms. The actuator may be a lockable gas spring that may be adjusted to a plurality of lengths. Each length of the gas spring may correspond to a different position of the support structure relative to the support arms.

The patient support apparatus may include a mattress assembly and the mattress assembly may include a cushion supported on the removable deck section. The removable deck section and the cushion may be coupled together to be removed from the support structure. The removable deck section and the cushion may be releasably coupled together. The cushion may be coupled to the removable deck section by a fastener. The fastener may be a two part fastener with a first part secured to the cushion and a second part secured to the removable deck section. The fastener may be a hook and loop fabric combination. The fastener may comprise a magnet.

In another aspect of the present disclosure, a patient support apparatus may include a lower frame, an upper frame, and a lift system for changing the elevation of the upper frame relative to the lower frame. The patient support apparatus may also include a thigh deck section pivotable relative to the upper frame and a foot deck section pivotable relative to the thigh deck section. The foot deck section may include a main section and a support structure pivotable relative to the main section. The foot deck section may also include an actuator coupled to the main section and the support structure. The actuator may have a variable length that corresponds to movement of the support structure relative to the main section. The foot deck section may also include a removable section supported on the support structure. The support structure may include a step and the support structure may be movable between a first position wherein the support structure supports the removable section such that the removable section and the main section cooperate to define a support surface and a second position wherein the step is positioned for use by a patient for egress from the patient support apparatus.

The main portion may include two support arms which are laterally spaced to define an opening and the support structure may support the removable section in the opening.

The patient support apparatus may be movable between a bed configuration and a chair egress configuration. In the chair egress configuration, the removable section may be removed from the support structure. When the removable section is removed, the support structure may be pivoted relative to the main section to position the step generally parallel to a surface supporting the patient support apparatus.

The patient support apparatus further may include a mattress assembly and the mattress assembly may include a main body supported at least on the thigh deck section and the main portion of the foot deck section. The mattress assembly may also include a cushion supported on the removable section.

The removable section may be releasably secured to the support structure.

The patient support apparatus may further include a foot panel forming a barrier. The foot panel may be supported from the main portion of the foot deck section. The foot panel may assist in securing the removable section to the support structure.

The actuator may be non-powered. In some embodiments, the actuator may be manually adjustable to vary the length. In other embodiments, the actuator may include a motor to change the length of the actuator to vary the position of the support structure relative to the main portion of the foot deck section.

The support structure may include a body and the step may be pivotable relative to the body between a first position in which a first surface of the body and a first surface of the step are separated by ninety degrees and a second position wherein the first surface of the body and the first surface of the step are engaged.

Additional features and advantages of the invention will become apparent to those skilled in the art upon consideration of the following detailed description of illustrated embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of a patient support apparatus embodied as a hospital bed, the patient support apparatus including a foot deck section having a main portion and a removable section and an adjustable support structure that is pivotable relative to the main portion to permit a patient to egress from the foot end of the bed when the support structure is lowered relative to the main portion and the removable portion is removed;

FIG. 2 is a top view of the patient support apparatus of FIG. 1;

FIG. 3 is a side view of the patient support apparatus of FIG. 1 with portions removed;

FIG. 4 is a side view of the patient support apparatus of FIG. 1 with portions removed, with the foot deck section of the patient support apparatus raised to cause the foot deck section to pivot relative to a thigh deck section and the thigh deck section pivoted relative to an upper frame so that a foot end of the thigh deck section is raised relative to the head end of the thigh deck section;

FIG. 5 is a side view of the patient support apparatus similar to FIGS. 3 and 4, the removable section of the foot deck section removed and the support structure lowered;

FIG. 6 is a top view of the patient support apparatus of FIG. 1 with portions omitted; and

FIG. 7 is a side view of the removable section of the foot deck section of the patient support apparatus of FIG. 1.

### DETAILED DESCRIPTION OF THE DRAWINGS

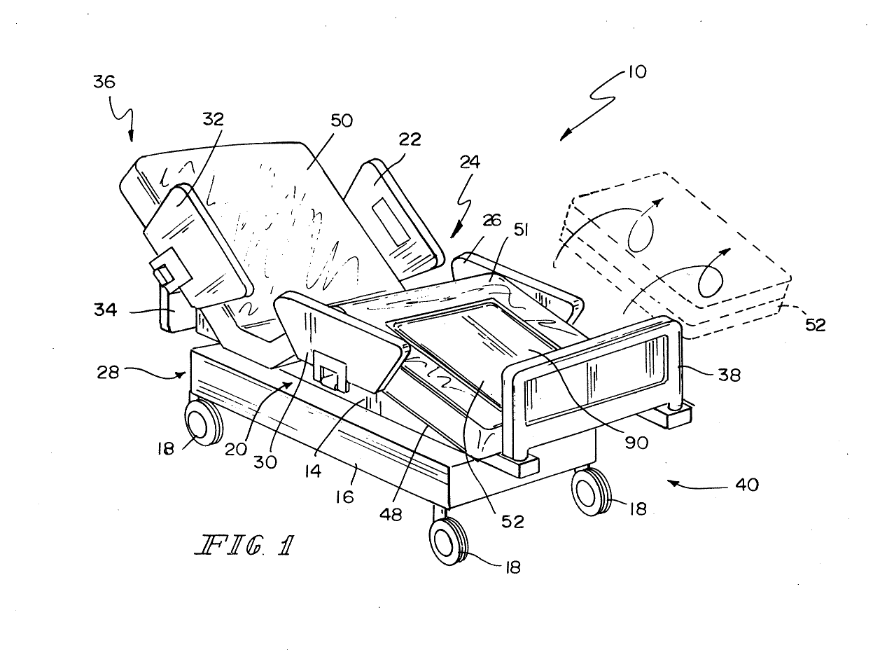

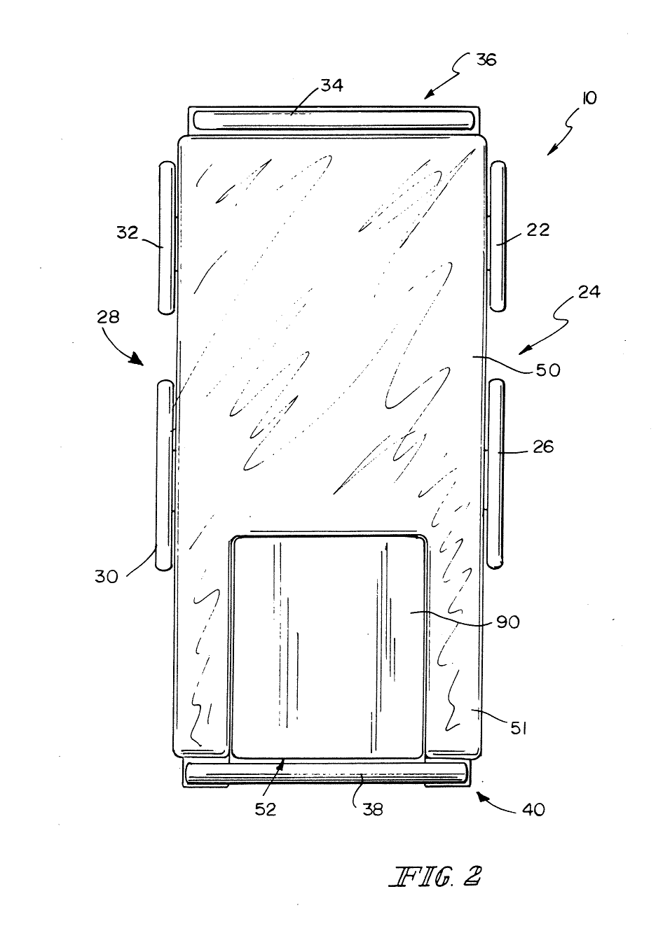

A patient support apparatus illustratively embodied as a hospital bed 10 is shown in FIGS. 1-6. The hospital bed 10 includes a deck 12, shown in FIG. 2, the deck 12 supported on an upper frame 14. The upper frame 14 is supported on a lower frame 16 with a lift system 20 positioned between the lower frame 16 and the upper frame 14, the lift system 20 operable to vary the height of the upper frame 14 relative to a floor 120 supporting the hospital bed 10. The lower frame 16 is supported on a number of casters 18 that contact the floor 120 to support the hospital bed 10.

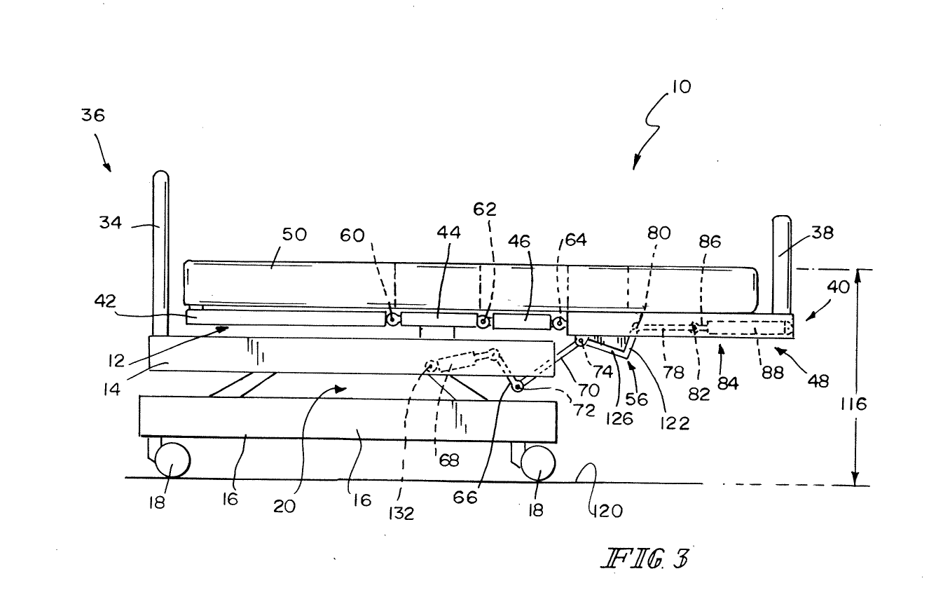

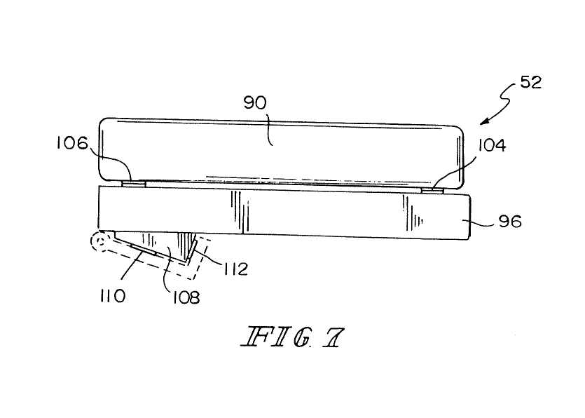

The deck 12 includes a head deck section 42 pivotable relative to a seat deck section 44 about a pivot axis 60 (shown in FIGS. 3-6). The seat deck section 44 is secured to the upper frame 14. A thigh deck section 46 is pivotable relative to the seat deck section 44 about a pivot axis 62. A foot deck section 48 is pivotable relative to the thigh deck section 46 about a pivot axis 64. A mattress assembly 50 is supported on the deck 12 and includes a main portion 51 and a cushion 90. The cushion 90 is supported on a portion of the foot deck section 48 as shown in FIG. 7 and discussed in further detail below.

Referring again now to FIG. 1, the hospital bed 10 also includes a siderail 22 positioned on the patient left 24 side of the hospital bed 10 and secured to the head deck section 42 so that the siderail 22 moves with the head deck section 42. The hospital bed 10 also includes a siderail 26 supported on the upper frame 14 and positioned on the patient left 24 side of the hospital bed 10. Another siderail 32 is positioned on the patient right 28 side of the hospital bed 10. Yet another siderail 30 is also positioned on the patient right 28 and is supported from the upper frame 14 opposite the siderail 26. A head panel 34 is supported on the upper frame at a head and 36 of the hospital bed 10. A foot panel 38 is supported from the foot deck section 48 at the foot and 40 of the hospital bed 10. The siderails 22, 26, 32, 30 and the head panel 34 and the foot panel 38 each function as a barrier adjacent portions of the mattress assembly 50 and serve as a deterrent for a patient who may attempt to egress from the hospital bed 10 without assistance from a caregiver.

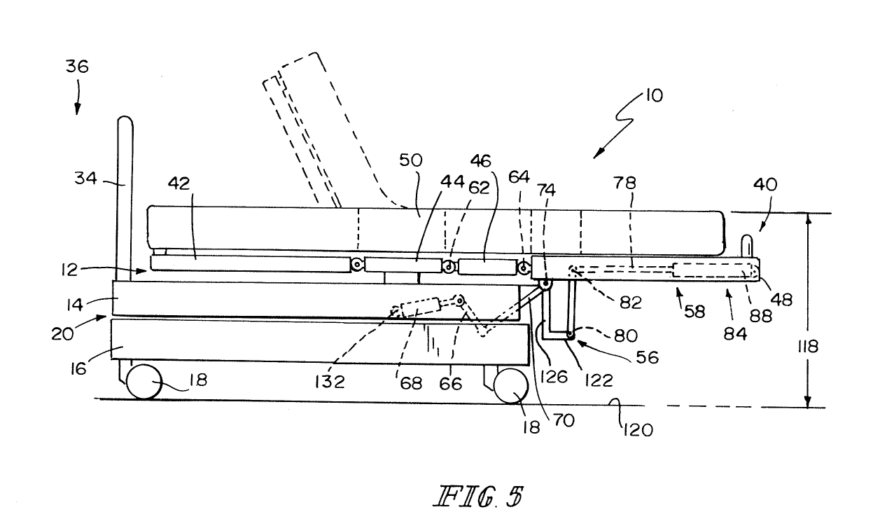

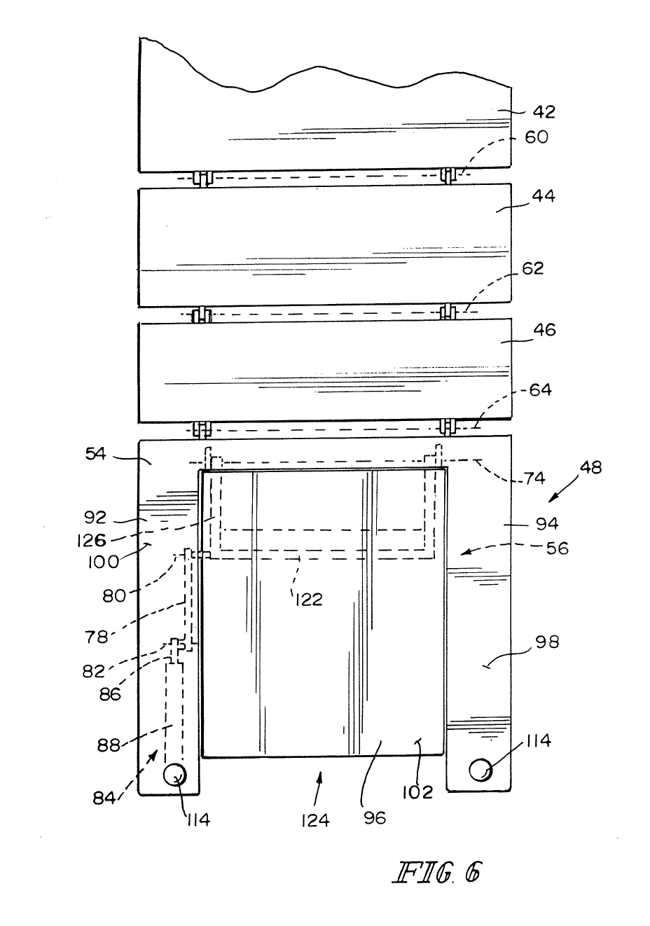

The hospital bed 10 and specifically the head deck section 42, thigh deck section 46, and portions of the foot deck section 48 are movable between a bed position as shown in FIGS. 1 and 3 and a chair egress position as shown in FIG. 5. The position of the head deck section 42 when it is raised so that the bed 10 is in a chair egress position is shown in phantom in FIG. 5. When the hospital bed 10 is in the chair egress position, a removable section 52 of the foot deck section 48 and the foot panel 38 are removed from the hospital bed 10 and a support structure 56 is lowered such that a space 124 (as indicated in FIG. 6, is created in the foot deck section 48 such that a patient may egress from the foot end 40 of the hospital bed 10. It should be understood that the reference to the patient left 24, patient right 25, head end 36, and foot end 40 are for orientation only and do not refer to any specific structure of the hospital bed 10.

Referring now to FIG. 7, the removable section 52 includes a deck section 96 and a guide 108 coupled to the deck section 96, the guide 108 is engageable with the support structure 56 to position the removable section 52 on the support structure 56. The guide 108 engages a step 122 and an arm 126 of the support structure 56 and is retained on the support structure by two fasteners 110 and 112. Illustratively, the fasteners 110 and 112 are magnets that are secured to the guide 108 and magnetically adhere the deck section 96 to the support structure 56. In other embodiments, the fasteners 110 and 112 may include hook and loop fabric structures having one portion secured to the support structure 56 and another portion secured to the guide 108. Any of a number of fastening systems which allow the removable section 52 to be releasably secured to the support structure 56 may be used. As used herein, the term releasably secured means that the structures are secured together, but may be released from one another by a user without the use of tools or implements.

The removable section 52 includes a cushion 90 releasably secured to an upper surface 102 of the deck section 96 by a pair of fasteners 104 and 106. In the illustrative embodiment, the fasteners 104 and 106 comprise a hook and loop fastening system with a first part secured to the cushion 90 and a second part secured to the deck section 96 so that the cushion is removably secured to the deck section 96.

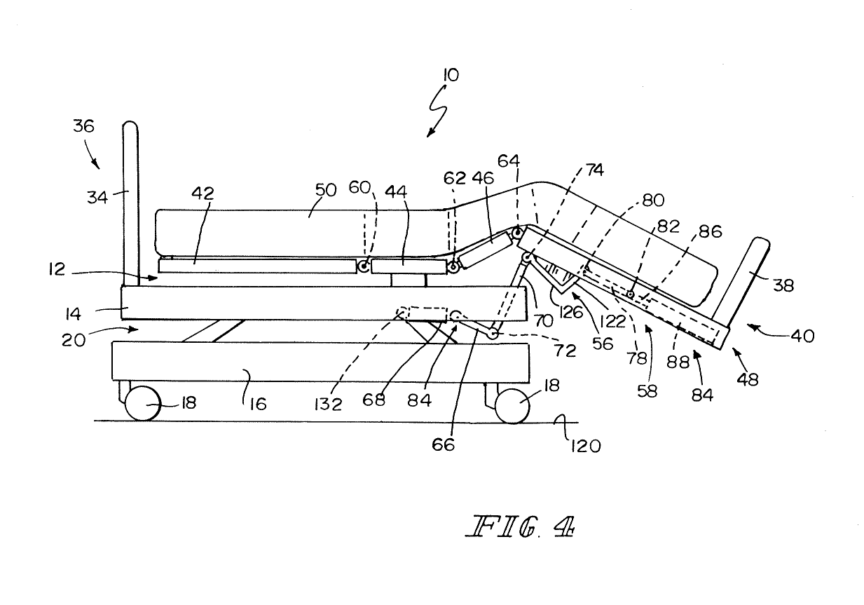

The foot deck section 48 is supported for pivotal movement about the pivot axis 64 by a foot section drive 84 that includes an actuator 68 that pivots about an axis 132 shown in FIG. 3. The foot section drive 84 includes a drive arm 66 that pivots about an axis 72. A link 70 is coupled to the drive arm 66 so that the drive arm 66 and link 70 pivot about the pivot axis 72. The link 72 is pivotably coupled to the foot deck section 48 at a pivot axis 74 such that as the actuator 68 changes length, the foot deck section 48 moves relative to the thigh deck section 46 with the movement constrained by the pivot axis 62 where the thigh deck section 46 pivots relative to the seat deck section 44. For example, the foot section drive 84 may move the foot deck section 48 between the generally flat position shown in FIG. 3 and a raised position shown in FIG. 4. Movement that occurs as a result of actuation of the foot deck section drive 84 causes the entire foot deck section 48, including the support structure 56 and the removable section 52 to move together.

The foot deck section 48 includes a fixed section 54 and movement of the support structure 56 relative to the fixed section 54 is controlled by a drive mechanism 84 that includes an actuator 58 that is extendable and retractable to change the position of the support structure 56 relative to the fixed section 54. The fixed section 54 includes a pair of support arms 92 and 94 with support arm 92 positioned on the patient right 28 of the foot deck section 48 and support arm 94 positioned on the patient left 24 side of the foot deck section 48. The support arms 92 and 94 are spaced apart to define the space 124 therebetween. The fixed section 54 includes a pair of pegs 114 supported on each of the support arms 92 and 94 respectively. The foot panel 38 is positioned on the pegs 114 to support the foot panel 38 from the fixed section 54 of the foot deck section 48.

The support arm 92 includes an upper surface 100 and the support arm 94 includes an upper surface 98. The surfaces 98 and 100 cooperate with the upper surface 102 of the deck section 96 to define a support surface of the foot deck section 48 when the removable section 52 is positioned on the support structure 56.

The actuator 58, shown in phantom in FIG. 5, includes a housing 88 and a shaft 86 that extends telescopically from the housing 88. A link 78 is pivotably coupled to the shaft 86 so that the link 78 is pivotable about a pivot axis 82. The step 122 is pivotably coupled to the link 78 so that there is relative movement between the step 122 and the link 78 about a pivot axis 80. The arm 126 of the support structure 56 is pivotable relative to the fixed section 54 so that as the length of the actuator 58 is reduced, the support structure 56 pivots upwardly about the axis 74 to a fully raised position as shown in FIG. 3. The extension of the shaft 86 from the housing 88 reduces the distance between pivot axis 82 and pivot axis 74 to lower the step 122 to the position shown in FIG. 5, so that the step is parallel to the floor 120.

The removal of the removable section 52 permits the support structure 56 to be lowered to the position shown in FIG. 5 without any interference from the removable section 52 so that the upper frame 14 may be lowered from a raised height 116 shown in FIG. 3 to the lowered height 118 shown in FIG. 5. The step 122 may be used by an occupant of the bed 10 to support egress, especially for shorter occupants.

The actuator 58 of the drive mechanism 84 is illustratively an electrically powered actuator that extends and retracts to lower and raise the support structure 56 respectively. In some embodiments, the actuator 58 may comprise a locking gas spring with a release that is manually actuated by a user to allow a user to raise and lower the support structure 56. In other embodiments, the actuator may be a wrap-spring locked actuator that may be releasable to allow a user to vary the length of the actuator. One illustrative embodiment of such a device is a Mechlok® available from Porter Group, LLC of Novi, Mich.

The removable section 52 is maintained in position by the fasteners 110 and 112 as well as the retention action of the foot panel 38 when it is mounted to the fixed section 54 of the foot deck section 48. To provide for egress of the hospital bed 10 from the foot end 40, a caregiver will reposition portions of the bed 10. The head deck section 42 is pivoted to a raised position as shown in phantom in FIG. 5. The support structure 56 is partially lowered and the foot panel 38 and the removable section 52 is removed to expose the step 122. The support structure 56 is lowered completely and the upper frame 14 is lowered to an appropriate height for the size of the occupant of the bed 10. A caregiver then stands adjacent the fixed section 54 on either side of the hospital bed 10 and assists the occupant in the use of the step 122 to step down onto the floor 120.

In some embodiments, the step 122 is pivotable relative to the arm 126 of the support structure 56 to permit the step 122 to be moved into contact with the arm 126 so that the step 122 is positioned out of the way of a larger occupant egressing from the foot end 40 and who does not require the use of the step 122. The step may be releasably connected to the link 78 at the pivot axis 80 so that the step may be moved out of the way and maintained in engagement with the arm 126.

Although the invention has been described with reference to the preferred embodiments, variations and modifications exist within the scope and spirit of the invention as described and defined in the following claims.

1. A patient support apparatus comprising
a lower frame,
an upper frame,
a lift system for changing the elevation of the upper frame relative to the lower frame,
a thigh deck section pivotable relative to the upper frame, and
a foot deck section pivotable relative to the thigh deck section, the foot deck section including
a main section including laterally spaced apart support arms, the support arms defining a space therebetween,
an actuator coupled to the main section, the actuator having a variable length,
a removable section, and
a support structure pivotable relative to the main section, the support structure including a step, the support structure coupled to the actuator and movable, as the length of the actuator varies, between a first position wherein the support structure supports the removable section such that the removable section and the main section cooperate to define a support surface, and a second position wherein the step is positioned for use by a patient for egress from the patient support apparatus.

2. A patient support apparatus comprising
a lower frame,
an upper frame supported on the lower frame and vertically movable relative to the lower frame,
a first deck section pivotably coupled to the upper frame,
a second deck section pivotably coupled to the first deck section, the second deck section including a pair of support arms spaced apart to define a space therebetween, each support arm having an upper surface and a support structure pivotable relative to the pair of support arms between a first position and a second position, and
a removable deck section supported on the support structure, such that an upper surface of the removable deck section cooperates with the upper surfaces of the pair of support arms to form a generally continuous planar support surface when the support structure is in the first position.

3. The patient support apparatus of claim 2, wherein the support structure comprises a step and when the support structure is in the second position, the step is positioned such that the patient support apparatus fauns a chair from which a patient may egress.

4. The patient support apparatus of claim 3, wherein the support structure is coupled to an actuator, the actuator movable to cause the support structure to move between the first and second positions.

5. The patient support apparatus of claim 2, wherein the support structure is coupled to an actuator, the actuator movable to cause the support structure to move between the first and second positions.

6. The patient support apparatus of claim 5, wherein the actuator is lockable gas spring that may be adjusted to a plurality of lengths, each length of the gas spring corresponding to a different position of the support structure relative to the support arms.

7. The patient support apparatus of claim 6, wherein the patient support apparatus further comprises a mattress assembly including a cushion supported on the removable deck section, the removable deck section coupled together to be removed from the support structure.

8. The patient support apparatus of claim 5, wherein the actuator is an electrically powered linear actuator that may be adjusted to a plurality of lengths, each length of the actuator corresponding to a different position of the support structure relative to the support arms.

9. The patient support apparatus of claim 5, wherein the actuator is supported on the second deck section.

10. A patient support apparatus comprising
a lower frame,
an upper frame,
a lift system for changing the elevation of the upper frame relative to the lower frame,
a thigh deck section pivotable relative to the upper frame, and
a foot deck section pivotable relative to the thigh deck section, the foot deck section including a main section, a support structure pivotable relative to the main section, an actuator coupled to the main section and the support structure, the actuator having a variable length that corresponds to movement of the support structure relative to the main section, and a removable section supported on the support structure,
wherein the support structure comprises a step and the support structure is movable between a first position wherein the support structure supports the removable section such that the removable section and the main section cooperate to define a support surface, and a second position wherein the step is positioned for use by a patient for egress from the patient support apparatus.

11. The patient support apparatus of claim 10, wherein the main portion includes two support arms which are laterally spaced to define an opening and the support structure supports the removable section in the opening.

12. The patient support apparatus of claim 11, wherein the patient support apparatus is movable between a bed position and a chair egress position, wherein in the chair egress position, the removable section is removed from the support structure and the support structure is pivoted relative to the main section to position the step generally parallel to a surface supporting the patient support apparatus.

13. The patient support apparatus of claim 10, wherein the patient support apparatus further comprises a mattress assembly including a main body supported at least on the thigh deck section and the main portion of the foot deck section, and cushion supported on the removable section.

14. The patient support apparatus of claim 10, wherein the removable section is releasably secured to the support structure.

15. The patient support apparatus of claim 10, wherein the patient support apparatus further comprises a foot panel forming a barrier, the foot panel supported from the main portion of the foot deck section.

16. The patient support apparatus of claim 15, wherein the foot panel assists in securing the removable section to the support structure.

17. The patient support apparatus of claim 10, wherein the actuator is not powered.

18. The patient support apparatus of claim 17, wherein the actuator is manually adjustable to vary the length.

19. The patient support apparatus of claim 10, wherein the actuator includes a motor to change the length of the actuator to vary the position of the support structure relative to the main portion of the foot deck section.

20. The patient support apparatus of claim 19, wherein the support structure further comprises a body and the step is pivotable relative to the body between a first position in which a first surface of the body and a first surface of the step are separated by an angle of about ninety degrees and a second position wherein the first surface of the body and the first surface of the step are engaged.
